(19) United States
(12) Patent Application Publication
(10) Pub. No.: US 2011/0119217 A1
(43) Pub. Date: May 19, 2011

(54) APPARATUS AND METHOD FOR RECOMMENDING SERVICE

(75) Inventors: Ae-Kyeung Moon, Daejeon-si (KR); Yoo-Mi Park, Daejeon-si (KR); Sang-Ki Kim, Daejeon-si (KR)

(73) Assignee: Electronics and Telecommunications Research Institute, Daejeon (KR)

(21) Appl. No.: 12/894,786

(22) Filed: Sep. 30, 2010

(30) Foreign Application Priority Data
Nov. 19, 2009 (KR) 10-2009-0112079

(51) Int. Cl. G06N 5/02

(52) U.S. Cl. 706/46

(57) ABSTRACT

Provided are a service recommending apparatus and method. The service recommending method uses situation information, such as location information of a terminal possessed by a user and a user profile, to deduce the user's activity, predicts a service that is expected to be preferred by the user according to the user's situation, and provides the result of the prediction to the user. The location information of the terminal is acquired from a network server such as a location information server through an open API gateway.

### CROSS-REFERENCE TO RELATED APPLICATION

This application claims the benefit under 35 U.S.C. §119(a) of a Korean Patent Application No. 10-2009-0112079, filed on Nov. 19, 2009, the entire disclosure of which is incorporated herein by reference for all purposes.

### BACKGROUND

1. Field

The following description relates to a network, and more particularly, to an apparatus and method for providing preferred services based on ontology in a network.

2. Description of the Related Art

Development of a Ubiquitous computing environment for accessing a network without regard to time and place for communications is actively on the way. In a wired/wireless communication environment after 3^{rd} generation (3G), terminals for individuals are expected to be able to access more various kinds of communication networks. With this trend, a service providing technology capable of providing personalized services to which personalized communication environments and situations have been reflected is needed. For such a service providing technology, a knowledge management technology which processes and provides network information according to users' situations should be developed.

One of methods for recognizing a user's situation to deduce the user's activity is using a learning algorithm, such as a Bayesian Network and a Neutral Network. Also, a method of extracting a predetermined pattern based on a user's activity pattern and the user's past history information has been developed. However, these conventional methods have difficulties in providing information in real time since past history information about users' activities has to have been accumulated in advance.

Furthermore, sine the methods are based on a sensor and accordingly applicable only in limited spaces, such as a laboratory, a meeting room and a home domain environment, more studies are needed to apply the methods to an open environment such as a mobile environment. Also, the methods require an additional location sensor such as GPS to acquire users' location information.

### SUMMARY

The following description provides an apparatus and method for providing services to which an individual is expected to prefer by perceiving the individual's situation without utilizing a sensor.

According to an aspect, there is provided a service recommending method based on ontology, including: acquiring location information of a user terminal from a network server; deducing a user activity according to the location information of the user terminal based on ontology-based information; predicting a user preferred service according to the result of the deduction; and providing the user preferred service to the user.

According to another aspect, there is provided a service recommending apparatus based on ontology, including: an information collector configured to acquire location information of a user terminal from a network server; an activity deduction unit configured to deduce a user activity according to the location information of the user terminal based on ontology-based information; and a service selector configured to select a user preferred service based on the deduced user activity and to provide the user preferred service to the user.

Therefore, the service providing method and apparatus allow service providers as well as network operators to use a service providing function, and are also applicable to converged and mixed services for various domains, such as communication domain application services, IT broadcasting, telematics, etc.

Also, the service providing method and apparatus may provide services that are predicted to be preferred by a user by reflecting the user's service preference when no user activity information is accumulated.

Other features and aspects will be apparent from the following detailed description, the drawings, and the claims.

### BRIEF DESCRIPTION OF THE DRAWINGS

FIG. 1 is a diagram illustrating an example of a service recommending system.

FIG. 2 is a diagram illustrating an example of a service recommending apparatus.

FIG. 3 illustrates a configuration example of address ontology.

FIG. 4 illustrates a configuration example of a user class ontology model.

FIG. 5 is a flowchart illustrating an example of a service recommending method.

FIG. 6 is a flowchart illustrating an example of a method of extracting a place type.

FIG. 7 is a flowchart illustrating an example of a method of creating a list of preferred services.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

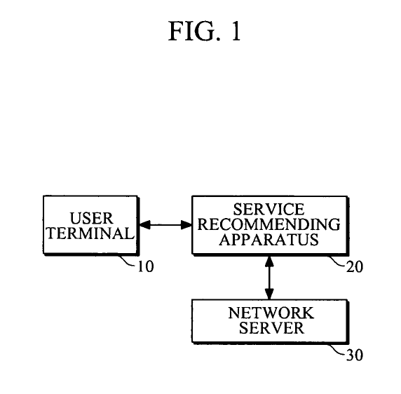

FIG. 1 is a diagram illustrating an example of a service recommending system.

Referring to FIG. 1, the service recommending system includes a user terminal 10, a service recommending apparatus 20 and a network server 30.

The user terminal 10 may be a mobile phone, a PDA or the like. The user terminal 10 may be one of various devices over a Ubiquitous environment, such as a homenetwork, robotics, a Ubiquitous Sensor Network (USN) and telematics.

An application program for communicating with the service recommending apparatus 20 is installed in the user terminal 10. The application program functions to receive a recommendation on an appropriate service that is suitable to a user's current situation, from the service recommending apparatus 20 through networking, and inform the user of the preferred service. In more detail, the application program installed in the user terminal 10 requests, when receiving a user's manipulation, the service recommending apparatus 20 to send information on services that are expected to be suitable to the user's current situation. Thus, the application program receives information on services (for example, Digital Multimedia Broadcasting (DMB) watching, radio listening, MP3 replay, Internet connection, etc.) that are expected to be preferred by the user, from the service recommending apparatus 20. Then, when the user selects one of the preferred services, the application program accesses the selected service to allow the user to use the service.

The network server 30 may be at least one of a Home Subscriber Server (HSS), a Location Based Service (HBS) server, a Home Location Rocator (HLR) and a presence server.

Details for a general configuration of each server on a network will be not described herein.

The service recommending apparatus 20 provides each of a plurality of user terminals 10 with a list of services that are expected to be preferred by the corresponding user according to the user's situation. The service recommending apparatus 20 uses an IP Multimedia System (IMS) as a communication infrastructure. In the current example, the service recommending apparatus 20 collects information about the user's situation from the network server 30 and predicts the user's current situation based on the collected information. Here, the information about the user's situation is information representing the user's current environment, and for example, may be the user's location, the user's activity, a current time, etc. The service recommending apparatus 20 predicts services that are preferable by the user according to the predicted user's situation, and creates a list of preferred services. According to an example, communications between the service recommending apparatus 20 and the user terminal 10 may be based on Transport Control Protocol/Internet Protocol (TCP/IP) or User Datagram Protocol/Internet Protocol (UDP/IP).

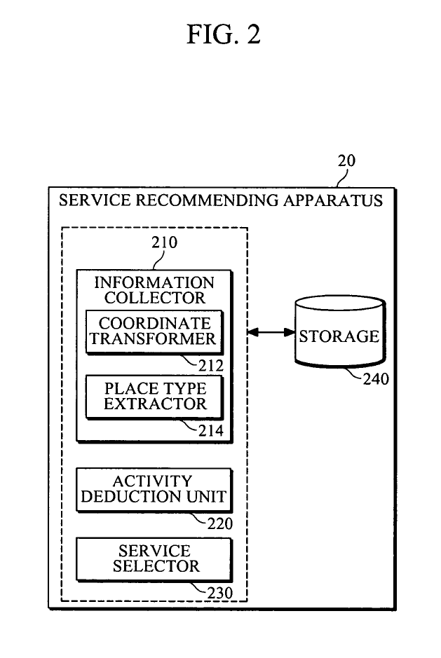

FIG. 2 is a diagram illustrating an example of the service recommending apparatus 20.

Referring to FIG. 2, the service recommending apparatus 20 includes an information collector 210, an activity deduction unit 220, a service selector 230 and a storage 240.

The information collector 210 accesses an open service gateway through an open interface. Then, the information collector 210 collects information about a user's situation from a network server, such as IMS HSS (Home Subscriber Server), a LBS server, HLR and a presence server, through the open service gateway. According to an example, the information collector 210 acquires terminal location information provided over an IMS-based convergence network from a HSS, and receives metadata, such as a user's activity and a place type, from a presence server. In addition, the information collector 210 may acquire personal information such as schedule information for a possessor of a user terminal over a network.

The open interface means a standardized interface between an application service layer and a network transport network layer. The open interface is an interface into which functions of a network are abstracted, and allows accesses to functions and information of various communication networks, such as a Public Switching Telephone Network (PSTN), a Mobile Telecommunication Network (MTN), a data communication network and a space cable network.

The open service gateway is a gateway that uses an open interface to transport requests for a network from the Internet. The open service gateway transports the requests for the network to the network after converting the requests to a protocol recognizable by the network, receives a response from the network and then returns the response to an individual that has issued the requests. The open service gateway supports a diameter protocol that provides a function of requesting terminal location information, in order to connect to a HSS server.

According to an example, the information collector 210 includes a coordinate transformer 212 and a place type extractor 214. The coordinate transformer 212 acquires location information of a terminal from a HSS and a LBS server. In the current example, it is assumed that terminal location information acquired from a network server is location information of a user that possesses the corresponding terminal. Here, the terminal location information may be expressed as coordinate values consisting of latitude and longitude, such as (latitude 37.432021, longitude −122.083739). The coordinate transformer 212 uses geocoding to transform the user's location information to an address such as (“1600 amphitheatre parkway, mountain View, Calif.”). Transformation to an address may be based on address ontology. The address ontology has a subclass structure for representing address layers.

The storage 240 stores users' profiles and ontology information. The users' profiles include basic information for each user, such as the age, gender, occupation, etc. of the user and additional information, such as the preferences, schedule, etc. of the user. Ontology includes such address ontology that has place type information of a place corresponding to each address.

The place type extractor 214 extracts a place type corresponding to the address transformed by the coordinate transformer 212, based on the address ontology. For example, when the address is “Hyundai Department Store”, the place type extractor 214 may extract place type information “shopping” from the address “Hyundai Department Store”.

The activity deduction unit 220 deduces the user's situation and activity based on the user information and network context collected and recognized by the information collector 210. According to the current example, the activity deduction unit 220 uses various kinds of information, such as the place type information, the user's schedule and occupation information from the user's profile, and time information, to deduce the user's current situation and activity based on ontology.

In addition, the user activity information can be used for a search service. When the user arrives at a specific place, different search results may be provided according to whether the user's activity information is “shopping” or “on business”. For example, in association with a search keyword “Nike”, the activity deduction unit 220 may filter only specific content, such as information about the Nike company and sales information, as search results to provide to a person who is looking for a business, or assign higher priority to business-related information among data of search results and then provide the data to the person who is looking for a business. For example, the activity deduction unit 220 may display the search results on the upper portion of a screen. Meanwhile, the activity deduction unit 220 may assign higher priority to information about Nike Shopping malls, price information of products, etc. and then provide the search results to a person who wants shopping.

The service selector 230 uses the deduced results by the activity deduction unit 220 to select services that are expected to have higher preferences, and provides a list of the preferred services to the user.

At this time, the service selector 230 may obtain a preference of each service by assigning weights to user preference information input by the user and service usage history information acquired through learning, and select preferred services based on preferences of individual services. Accordingly, the service selector 230 may select services that are expected to be preferred by the user even when the user's activity information has not been accumulated. As more service usage history information is accumulated, the service selector 230 may assign a higher weight to the service usage history information acquired through learning.

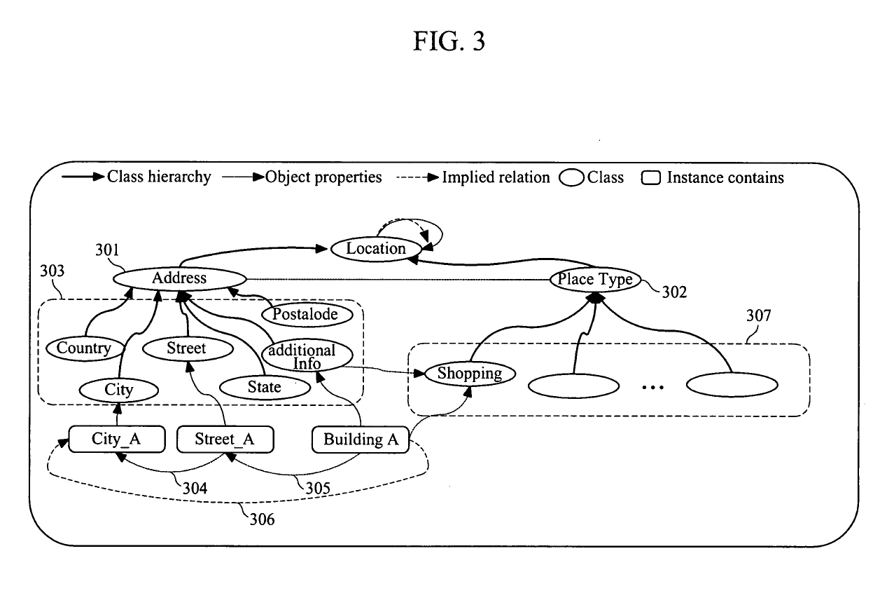

FIG. 3 illustrates a configuration example of address ontology.

Referring to FIGS. 2 and 3, the coordinate transformer 212 of the information collector 210 transforms coordinate values of (latitude, longitude) received from the HSS/LBS to an address. For example, the coordinate transformer 212 transforms coordinate values of (north latitude 37, east longitude 180) to an address “COEX Convention Center Samsung-dong, Gangnam-gu, 135-731, Seoul Korea”. In order to store such an address, a hierarchical structure of addresses and place type information are needed. Accordingly, the address ontology is composed of address 301 and place type 302. An address may have a plurality of place types. In order to represent an address layer, the following subclass 303 is configured.

| Name | Content |
|---|---|
| Country | Country Code |
| State | Country Administration, State, Do |
| City | City |
| Street | Street, Dong |
| Additional Info. | Additional Location Information |
| | (Building Name, Firm Name, . . .) |
| Code | Postal Code |

The address ontology is defined using transitive property in order to represent a hierarchical structure between address instances. If a property p is transitive, when instances A, B and C are connected in the form of A-P-B (304) and B-P-C (305), a relationship of A-P-C (306) may be automatically deduced. According to an example, place types may be designated with reference to a presence defined in Internet Engineering Task Force (IETF), as follows.

Aircraft, Airport, Exhibition Hall, Car, Bank, Bar, Bus, Bus Stop, Café, Classroom, Club, Government and Public Office, Hospital, Hotel, Motorcycle, Factory, Parking Lot, Public Transportation, Restaurant, School, Shopping Mall, Railroad Station, Theater, Outdoor, Church, Library, Train, Warehouse (Wholesale), Ship, Sea, Stadium, Office, Subway, etc.

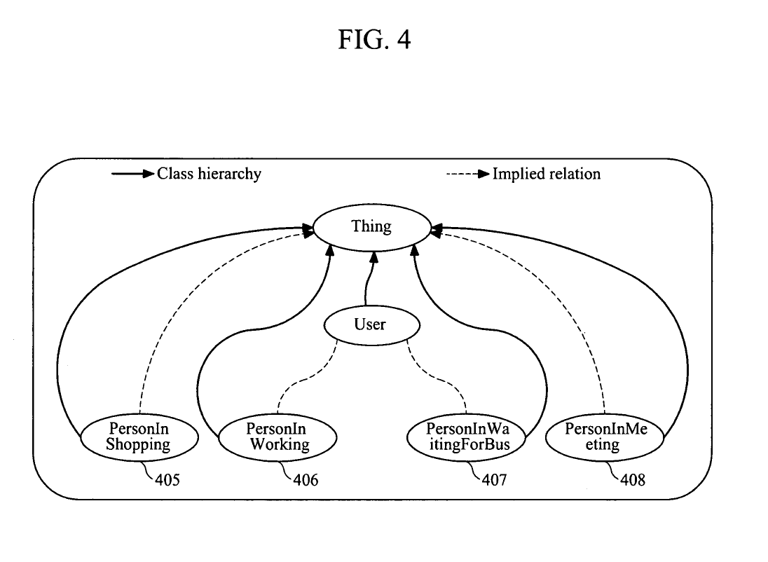

FIG. 4 illustrates a configuration example of a user class ontology model.

User class ontology of the service recommending apparatus 20 (see FIG. 2) defines user activities, such as driving, meeting, shopping, public transportation, working, meal and church service, with reference to an IETF presence. For example, the user class ontology includes a deduction rule for four activities of PersonInshopping 405, PersonInWorking 406, PersonInWaitingForBus 407 and PersonInMeeting 408.

As illustrated in FIG. 4, the four activities are defined using a TBox rule of ontology. A user activity may be deduced to one of the four activities based on the user's situation information. For example, the activity PersonInMeeting 408 may be deduced based on the user's situation information, such as a location, a role, a schedule and a device status.

Ontology is divided into Terminological Box (TBox) and Assertional Box (ABox). TBox represents a schema of ontology and ABox represents instances. Here, the schema is a kind of mechanism for controlling activities to allow a percipient to selectively receive and view a certain type of information, and instances are objects belonging to individual factor levels of a certain group.

TBox deduction means deducing a subsumption relationship, which allows deducing a relationship between a class and a subclass. The subsumption relationship means that a certain class includes another class.

According to an example, the service recommending apparatus 20 uses TBox deduction to deduce a user's activity. As a deduction result according to the TBox deduction rule, PersonInshopping 405, PersonInWorking 406, PersonInWaitingForBus 407 and PersonInMeeting 408 are created as subclasses of a user class.

A user belonging to a specific activity class may have a plurality of class types. For example, a certain user may belong to both the PersonInWorking class and the PersonInMeeting class.

Upon activity deduction, a user activity may be decided using only a place type, however, when the place type is a complex place type, the user activity may be deduced using additional information, such as a schedule, an occupation, a time and so on, together with the place type. A place “COEX” belongs to a complex place type having multiple place type information such as “Conference Hall” and “Shopping Mall”. For example, when a user arrives at “COEX”, additional information, such as the schedule and acquaintances of the user and a current time, is used to recognize whether the user is in shopping or in meeting.

As another example, when the type of a place at which a user is located is a meeting room, an item “Meeting” is set to schedule information of the user and the occupation of the user is “officeworker”, the user's situation may be deduced as “in meeting”.

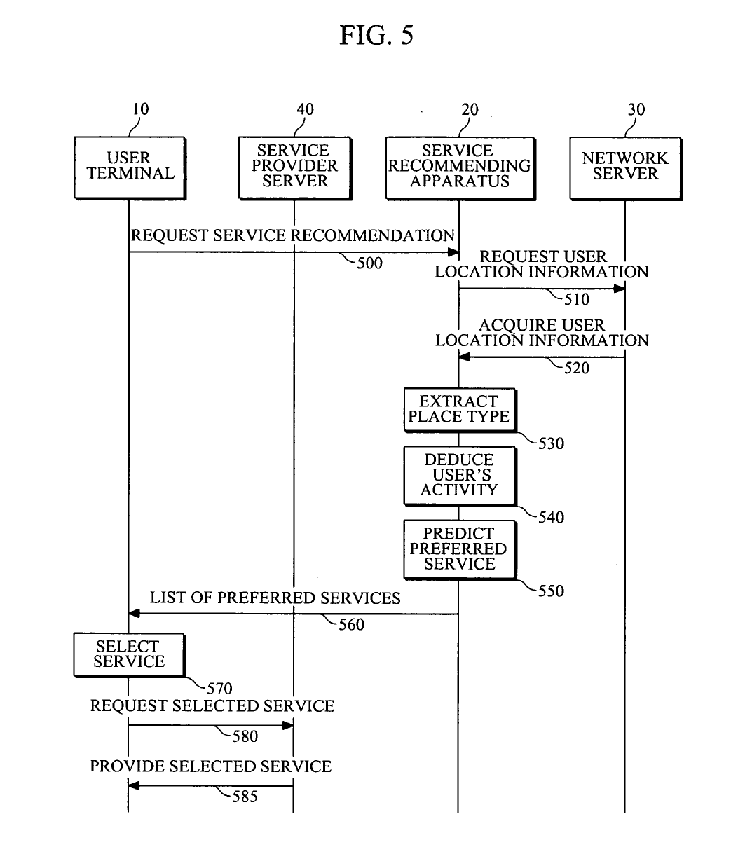

FIG. 5 is a flowchart illustrating an example of a service recommending method.

Referring to FIGS. 1 and 5, first, a user may use a user terminal 10 to request the service recommending apparatus 20 to send a service recommendation (500). The service recommending apparatus 20 requests a network server 30 to send user location information (510) and acquires user location information from the network server 30 (520). Then, the service recommending apparatus 20 extracts a place type of a place at which the user is located, based on the acquired user location information (530). Then, the service recommending apparatus 20 deduces the user's activity, etc. based on the place type (540). Successively, the service recommending apparatus 20 predicts services that are expected to be preferred by the user, based on the deduced user's activity (550). Then, the service recommending apparatus 20 creates the services that are expected to be preferred by the user as a list of preferred services and provides it to the user terminal 10 (560). Thereafter, the user selects one of services included in the list of preferred services using the user terminal 10 (570). The user terminal 10 accesses a service provider server 40 that provides the selected service (580). The user terminal 10 receives the service from the service provider server 40 (585).

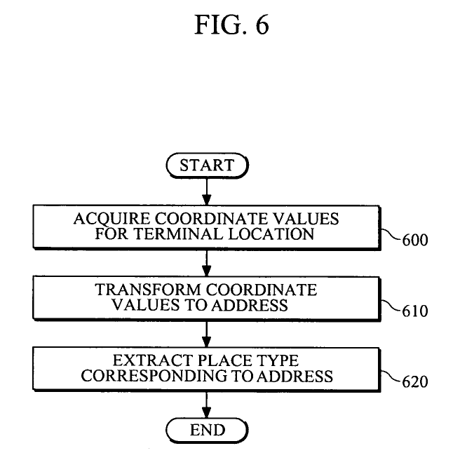

FIG. 6 is a flowchart illustrating an example of a method of extracting a place type.

Referring to FIG. 6, location information of a terminal is acquired in the form of coordinate values of latitude and longitude from a network server, such as a HSS and LBS (600). Then, the acquired coordinate values are transformed to an address (610). Successively, a place type corresponding to the address is extracted based on address ontology (620).

Here, place type information of address ontology may be configured as standardized metadata of a presence server. By configuring address information based on ontology, a place belonging to a plurality of place types can be easily changed to different place types.

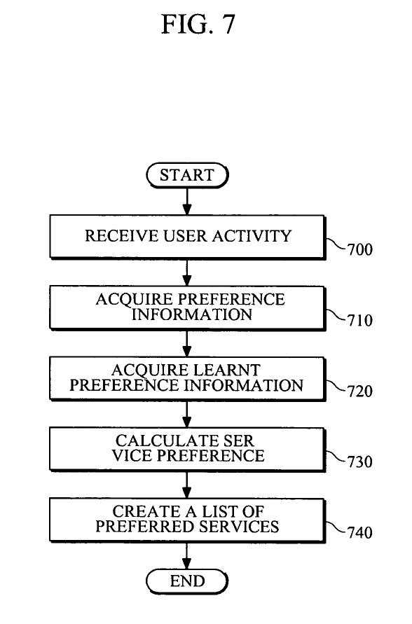

FIG. 7 is a flowchart illustrating an example of a method of creating a list of preferred services.

A category of services that a user is expected to use in the near feature can be provided by using the user's preferences and activity-based service usage pattern information.

For example, when a user's family arrives at an international airport, a fact that they are on holiday or on a trip may be deduced. Accordingly, in this case, it can be predicted that they will prefer to a “Travel Information” service.

Referring to FIG. 7, when a user activity is input through a user terminal (700), preference information set by the user is acquired from a user profile (710). For example, preference information of a user i may be in the form of Pᵢ={{svc₁, w₁}, {sv₂, w₂}, . . . , {svcₖ, wₖ}}. Then, a learnt user service usage pattern is acquired (720).

The learnt user service usage pattern corresponds to learnt information about a preference on activity {activity, service log value (LV)}. A Learnt Value (LV) represents a group of (Service Category, Service Usage Log(SUL)) pairs for each activity, and is expressed in the form of LVᵢ^{j}={aⱼ, {{svc₁,SULᵢ^{j1}}, {svc₂,SULᵢ^{j2}}, . . . {svcₖ,SULᵢ^{jk}}}}, where aⱼ represents activity j and SULᵢ^{j1} represents preference learnt information of a service having a service preference for a user's activity j1. The user's activity j1 may be one of PersonInshopping 405, PersonInWorking 406, PersonInWaitingForBus 407 and PersonInMeeting 408.

Then, a service preference may be calculated using the preference information set by the user and the learnt user service usage pattern information, as follows (730):

Scoreᵢ(sc)=α*Pᵢ+β*LVᵢ^{j},

where weights α and β are variable and initially set to satisfy α>>β for computation based on a preference score input by a user, and the β value may increase as a user service usage history is accumulated. Also, as reliability of the user service usage pattern is higher, the α and β values are set to satisfy α<<β.

Also, as the calculated service preference score scoreᵢ(sc) is greater, the corresponding service is determined to be a service that is expected to be preferred by the user. Accordingly, a predetermined number of services having higher preference scores are created as a list of preferred services and the list of preferred services is provided to the user.

Meanwhile, the service recommending method described above may be written in the form of a computer program. Also, the computer program may be stored in a computer readable media and implemented by being read and executed by a computer. The computer readable media includes a magnetic tape, an optical data storage, etc.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A service recommending method based on ontology, comprising:
acquiring location information of a user terminal from a network server;
deducing a user activity according to the location information of the user terminal based on ontology-based information;
predicting a user preferred service according to the result of the deduction; and
providing the user preferred service to the user.

2. The service recommending method of claim 1, wherein the deducing of the user activity comprises:
extracting place type information corresponding to the location information of the user terminal; and
deducing the user activity based on the place type information.

3. The service recommending method of claim 1, wherein the predicting of the user preferred service comprises predicting the user preferred service based on service preference information input by the user.

4. The service recommending method of claim 1, wherein the predicting of the user preferred service comprises predicting the user preferred service based on service usage history information of the user.

5. The service recommending method of claim 1, wherein the predicting of the user preferred service comprises obtaining a preference of each service by assigning weights to preference information input by the user and service usage history information of the user, wherein as more service usage history information is accumulated, a higher weight is assigned to the service usage history information.

6. The service recommending method of claim 1, after acquiring the location information of the user terminal, further comprising transforming the location information of the user terminal to an address, wherein the acquired location information is in the form of coordinate values.

7. The service recommending method of claim 1, further comprising acquiring presence information of the user, and
the deducing of the user activity comprises deducing the user activity based on the presence information.

8. A service recommending apparatus based on ontology, comprising:
an information collector configured to acquire location information of a user terminal from a network server;
an activity deduction unit configured to deduce a user activity according to the location information of the user terminal based on ontology-based information; and
a service selector configured to select a user preferred service based on the deduced user activity and to provide the user preferred service to the user.

9. The service recommending apparatus of claim 8, wherein the information collector comprises a place type extractor configured to extract a place type corresponding to the location of the user terminal, and the activity deduction unit deduces the user activity based on the place type.

10. The service recommending apparatus of claim 9, wherein the information collector further comprises a coordinate transformer configured to transform the location information of the user terminal to an address, wherein the acquired location information is in the form of coordinate values.

11. The service recommending apparatus of claim 8, wherein the service selector selects the user preferred service based on service preference information input by the user.

12. The service recommending apparatus of claim 8, wherein the service selector selects the user preferred service based on service usage history information of the user.

13. The service recommending apparatus of claim 8, wherein the service selector obtains a preference of each service by assigning weights to preference information input by the user and service usage history information of the user, wherein as more service usage history information is accumulated, a higher weight is assigned to the service usage history information.

14. The service recommending apparatus of claim 8, wherein the information collector further acquires presence information of the user, and the activity deduction unit deduces the user activity based on the presence information.

15. The service recommending apparatus of claim 8, wherein the network server is at least one server of a Home Subscriber Server (HSS), a Location Based Service (LBS) server and a Home Location Rocator (HLR).

16. The service recommending apparatus of claim 8, wherein the information collector uses an open interface.

17. The service recommending apparatus of claim 8, further comprising a storage configured to store a user profile including at least one of user location information, time information, activity information, and
wherein the service selector selects a service that is expected to be used by the user based on the information stored in the user profile.
